(19) United States
(12) Patent Application Publication
(10) Pub. No.: US 2010/0163399 A1
(43) Pub. Date: Jul. 1, 2010

(54) Water Treatment Process for Steam Plant

(75) Inventors: Nobuo Ishihara, Hyogo (JP); Sumio Yamauchi, Hyogo (JP); Kazutoyo Murata, Hyogo (JP); Masato Kanedome, Hyogo (JP); Yasuhiko Shoda, Tokyo (JP); Katsuhiko Yamakami, Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 12/224,044

(22) PCT Filed: Aug. 28, 2007
(86) PCT No.: PCT/JP2007/066655

§ 371 Date: Mar. 2, 2010

(30) Foreign Application Priority Data
Aug. 31, 2006 (JP) 2006-236214

(51) Int. Cl. C02F 5/08

(52) U.S. Cl. 203/7

(57) ABSTRACT

In a steam plant, scale adhesion to the inside of a specific device is prevented, while reducing the amount of an agent such as hydrazine to the lowest possible level. A temporary change in the chemical environment or an approximately periodic variation in the chemical environment is brought about in a channel (21) inside the prescribed device, during operation of the steam plant.

### TECHNICAL FIELD

The present invention relates to a water treatment process for a steam plant, employed in, for example, nuclear or thermal power generation. Specifically, the present invention relates to a water treatment process employed in a steam plant for preventing scale adhesion to a device, such as a feedwater pump, a drain pump, a feedwater booster pump, a heater, an orifice, or a control valve, which is installed in a channel of a circulatory system of the steam plant and is adversely affected by scale adhesion.

### BACKGROUND ART

For example, in a once-through boiler of a steam plant for thermal power generation, scale formed on the inner face of a generating tube has a tendency to become wave-like as the feedwater quality becomes better, and this wave-like scale causes an increase in flow loss of the once-through boiler.

There are known water treatment methods for reducing such wave-like scale, for example, a method of increasing hydrazine concentration in secondary system feedwater (refer to Patent Document 1), a method of injecting hydrazine at an economizer inlet of a thermal plant (refer to Patent Document 2), and a method of injecting an oxidizing agent such as oxygen, ozone, or hydrogen peroxide into feedwater (refer to Patent Documents 3 and 4).

These methods try to solve problems caused by scale adhesion to a boiler of a steam plant for nuclear or thermal power generation by reducing the amount of scale itself by suppressing elution of iron into the circulating water in a circulatory system by water treatment to reduce the amount of iron being carried into the boiler.

As an example, the conventional water treatment process for a thermal power plant disclosed in Patent Document 4 will be described with reference to FIG. 6. FIG. 6 is a flow diagram showing an example of a steam plant in a thermal power plant. In FIG. 6, 1 is a condenser, 2 is a low-pressure heater, 3 is a deaerator, 4 is a feedwater pump, 5 is a feedwater flow meter, 6 is a high-pressure heater, 7 is an economizer, 8 is a boiler, 9 is a turbine, 10 is an ammonia injector, 11 is a hydrazine injector, 12 is an electrical conductivity meter for controlling the injection volume of a dosing pump of the ammonia injector 10, and 13 is a hydrazine analyzer for controlling the injection amount of a dosing pump of the hydrazine injector 11.

First, the behavior of circulating water and steam of the circulatory system in the above-mentioned structure will be described.

After steam introduced into the condenser 1 from the turbine 9 is condensed to condensed water, this condensed water is preheated with the low-pressure heater 2, deaerated with the deaerator 3, further preheated with the high-pressure heater 6 and the economizer 7, and then fed to the boiler 8 to be heated into steam therein. This steam is then introduced into the turbine 9 to drive the turbine 9, thereby driving a generator (not shown). Then, the steam discharged from the turbine 9 enters the condenser 1 and is condensed back to water. The above-described cycle is then repeated.

Then, a water treatment process of the circulating water in this circulatory system will be described.

The above-mentioned devices, as well as pipes for connecting these devices, constituting a thermal power plant are mainly made of steel. In order to prevent iron oxide formed on these steel surfaces from eluting into the circulating water, the pH of the circulating water is usually controlled to 9.0 to 9.5 by steadily injecting an ammonia solution from the ammonia injector 10, which is connected to the pipe at the outlet side of the condenser 1, according to the value of the electrical conductivity meter 12 installed in the pipe at the inlet side of the deaerator 3. In addition, simultaneously, in order to deaerate the circulating water, hydrazine is injected into the circulating water with the hydrazine injector 11 installed in the pipe at the outlet side of the condenser 1 for maintaining the concentration of hydrazine remaining in the feedwater at the inlet of the economizer 7 in the range of, conventionally, 10 μg/L or more and, generally, 10 to 100 μg/L.

This control of the hydrazine injection amount is conducted so as to be proportional to the feedwater flow rate on the basis of the value detected with the feedwater flow meter 5 installed in the pipe at the discharging side of the feedwater pump 4 or according to the value detected with the hydrazine analyzer 13 at the inlet side of the economizer 7.

Patent Document 1: Japanese Unexamined Patent Application, Publication No. Sho 61-231306

Patent Document 2: Japanese Unexamined Patent Application, Publication No. Hei 2-280890

Patent Document 3: Japanese Unexamined Patent Application, Publication No. Sho 61-231307

Patent Document 4: Japanese Unexamined Patent Application, Publication No. Sho 63-15002

### DISCLOSURE OF INVENTION

The above-described conventional water treatment process for the steam plant focuses on inhibition of scale adhesion to, mainly, the inside of the steam generator (boiler), but does not focus on inhibition of scale adhesion to other portions of the channel for the circulating water in the circulatory system of the steam plant. Accordingly, the process has problems, for example, an increase in the differential pressure due to adhesion of projection- or wave-like scale to a steam vent in a steam generator, an increase in the differential pressure due to adhesion of wave-like scale to surfaces at water-flowing sides of an orifice and a nozzle of a flowmeter, an increase in the differential pressure due to adhesion of wave-like scale to the inner surface of a thin tube in a feedwater heater, and an increase in the driving steam volume or an increase in the electrical current of a driving motor due to adhesion of wave-like scale to an impeller in a feedwater pump.

Furthermore, hydrazine, which is used in the methods disclosed in the above-mentioned Patent Documents 1 and 2, is expensive and affects the environment, about which there is much concern. Accordingly, it has recently been required to reduce the amount of hydrazine used as much as possible.

In the methods disclosed in the above-mentioned Patent Documents 3 and 4, oxidizing agents are used. In the case of injecting an oxidizing agent into feedwater, measures for improving the durability of secondary system equipment are additionally necessary. Therefore, such methods are difficult to apply to nuclear power plants under present circumstances.

Furthermore, in a centrifugal pump used in a feedwater pump, water in a gap between the impeller surface opposite to the surface at the water-introducing side and the inner surface of a volute chamber hardly flows out to the outside, thus remaining in the gap. Scale is easily formed on the impeller surface in contact with this water remaining in the gap, which causes a decrease in efficiency of the centrifugal pump.

The present invention has been made under such circumstances, and an object thereof is to provide, in a steam plant employed in, for example, nuclear or thermal power generation, a water treatment process for the steam plant, wherein the above-mentioned various problems caused by scale adhesion are solved by preventing the scale adhesion to the inside of a specific device, while reducing the amount of an agent such as hydrazine to the lowest possible level.

The water treatment process for the steam plant of the present invention employs the following solutions for solving the above-mentioned problems.

That is, the water treatment process according to the present invention is for a steam plant including a steam generator for generating steam by heat from a heat source, a steam turbine driven by the steam from the steam generator, a condenser for condensing the steam exhausted from the steam turbine, a water feeder for feeding the water condensed in the condenser to the steam generator, and a circulation channel for sequentially connecting the steam generator, the steam turbine, the condenser, and the water feeder, wherein a change in the chemical environment is temporarily brought about in the channel inside a prescribed device disposed in the circulation channel, during operation of the steam plant.

According to this water treatment process for the steam plant, the water flowing in the channel inside the prescribed device of the steam plant is chemically affected by the above-described temporary change in the chemical environment in the channel inside the prescribed device for which scale adhesion is to be prevented. Consequently, the scale adhesion to the inside of the prescribed device can be prevented by using a small amount of an agent.

Furthermore, in the water treatment process according to the present invention for a steam plant including a steam generator for generating steam by heat from a heat source, a steam turbine driven by the steam from the steam generator, a condenser for condensing the steam exhausted from the steam turbine, a water feeder for feeding the water condensed in the condenser to the steam generator, and a circulation channel for sequentially connecting the steam generator, the steam turbine, the condenser, and the water feeder, a variation in the chemical environment may be brought about, approximately periodically, in the channel inside a prescribed device disposed in the circulation channel, during operation of the steam plant.

According to this water treatment process for the steam plant, a chemical oscillation is imparted to the water flowing in the channel inside the prescribed device of the steam plant by the above-described approximately periodic variation in the chemical environment in the channel inside the prescribed device for which scale adhesion is to be prevented. Consequently, the scale adhesion to the inside of the prescribed device can be prevented by using a small amount of an agent.

Furthermore, in the water treatment process according to the present invention for a steam plant including a steam generator for generating steam by heat from a heat source, a steam turbine driven by the steam from the steam generator, a condenser for condensing the steam exhausted from the steam turbine, a water feeder for feeding the water condensed in the condenser to the steam generator, and a circulation channel for sequentially connecting the steam generator, the steam turbine, the condenser, and the water feeder, the water feeder may be a centrifugal pump including a volute chamber and an approximately disk-shaped impeller rotatably arranged in the volute chamber and transferring water introduced to the center of the impeller from the outside of the volute chamber to the outside of the volute chamber from the circumference of the impeller by a centrifugal force caused by the rotation of the impeller; and a change in the chemical environment in a gap between the impeller surface opposite to the surface at the water-introducing side and the inner surface of the volute chamber is brought about during operation of the centrifugal pump.

According to this water treatment process for the steam plant, since the water in the gap between the impeller surface opposite to the surface at the water-introducing side and the inner surface of the volute chamber remains therein, it is not necessary to continuously inject an agent for changing the chemical environment, and the scale adhesion can be prevented by injecting a small amount of the agent.

According to the present invention, in a steam plant employed in, for example, nuclear or thermal power generation, there is provided a water treatment process for the steam plant, which can solve various problems caused by scale adhesion during operation of the steam plant by preventing scale adhesion to the inside of a specific device, while reducing the amount of an agent, such as hydrazine.

### BRIEF DESCRIPTION OF DRAWINGS

FIG. 1 is a flow diagram showing an example of a steam plant to be treated with the water treatment process according to first and second embodiments.

FIG. 2 contains graphs schematically showing examples of a change in pH of water in a channel of the steam plant of the first embodiment, where (a) shows a change in pH at an agent-injecting site, and (b) shows a change in pH in a feedwater pump.

FIG. 3 is a flow diagram showing an example of a steam plant to be treated with the water treatment process according to a third embodiment.

FIG. 4 is a schematic cross-sectional view illustrating a centrifugal pump viewed from the rotary axis direction of the impeller.

FIG. 5 is a schematic cross-sectional view illustrating a centrifugal pump viewed from the lateral direction of the rotary axis of the impeller.

FIG. 6 is a flow diagram showing an example of a steam plant in a thermal power plant.

### EXPLANATION OF REFERENCE SIGNS

1: condenser
2: low-pressure heater
3: deaerator
4: feedwater pump (prescribed device, water feeder)
4a: first feedwater pump (prescribed device, water feeder)
4b: second feedwater pump (the same type of device, water feeder)
6: high-pressure heater
8: boiler (steam generator)
9: steam turbine
21: channel
22: branched channel
25: dosing pump
26: pH meter
31: centrifugal pump
32: volute chamber
33: impeller
34: suction tube
35: discharge tube
36: guide blade
41: gap
42: scale
A: injection site
B: injection site
C: injection site

### BEST MODE FOR CARRYING OUT THE INVENTION

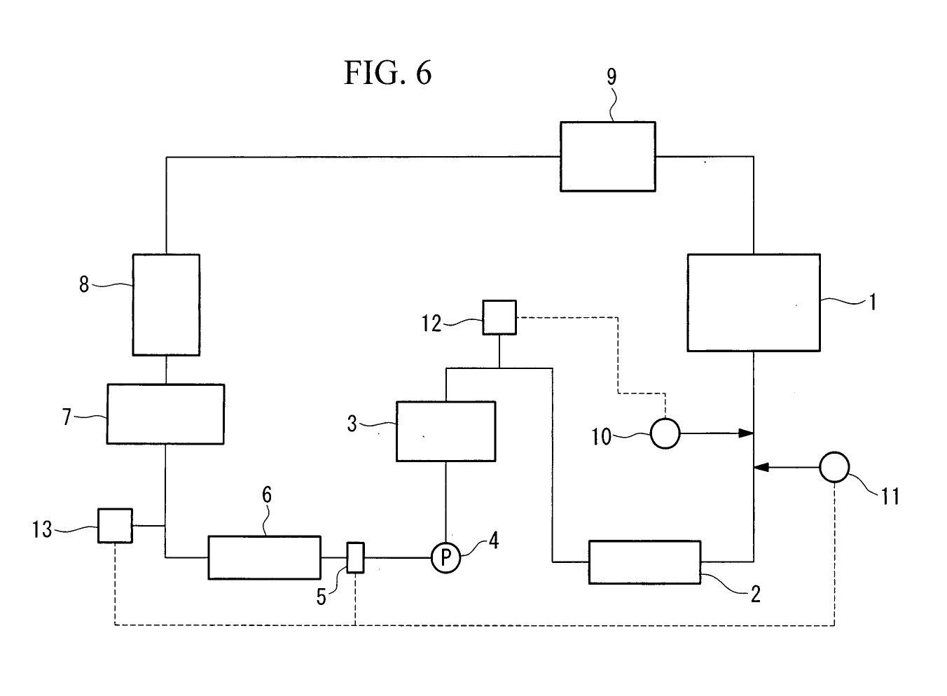

Embodiments of the water treatment process for a steam plant according to the present invention will now be described with reference to the drawings. The same components as those of the steam plant described in the section “Background Art” with reference to FIG. 6 are designated with the same reference numerals, and a description thereof is omitted.

### First Embodiment

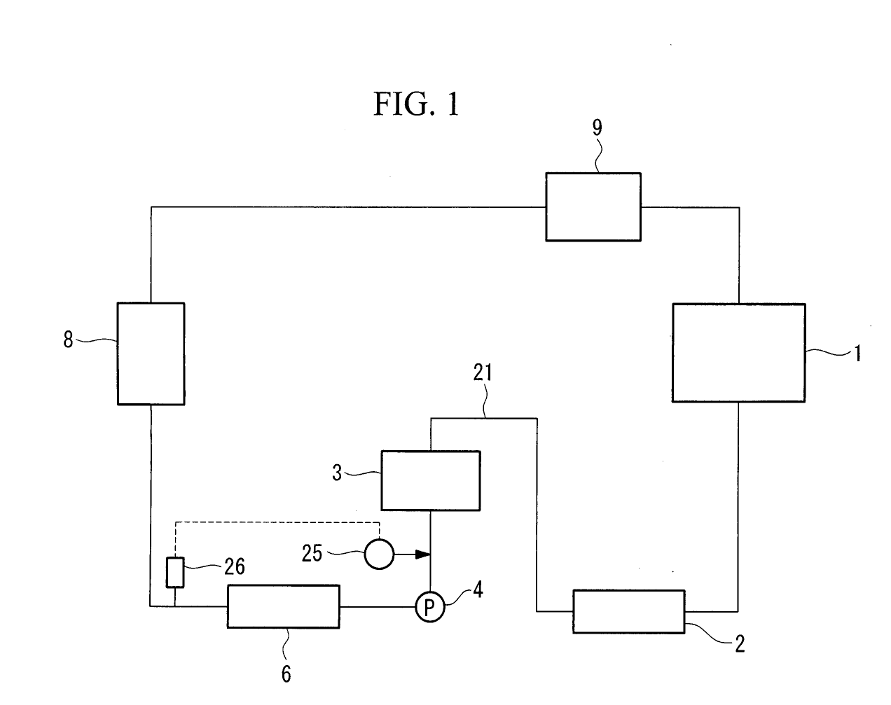

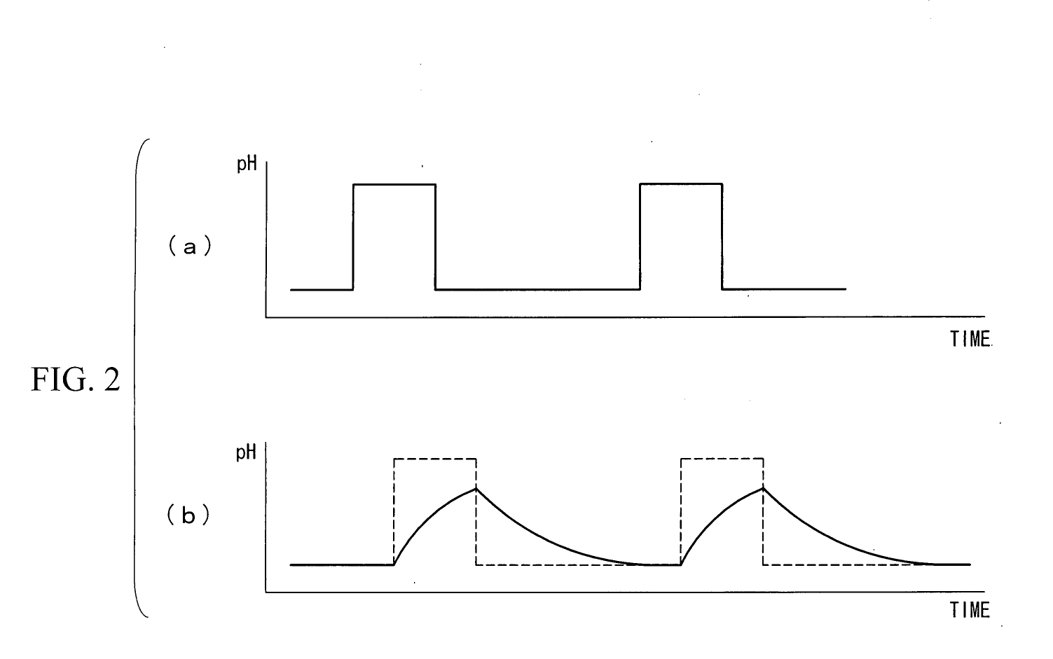

A water treatment process for a steam plant according to a first embodiment of the present invention will now be described with reference to FIGS. 1 and 2.

FIG. 1 is a flow diagram showing an example of a steam plant to be treated with the water treatment process according to the first embodiment.

The water treatment process for the steam plant according to the first embodiment is a process for treating water of a steam plant including a boiler 8 for generating steam by heat from a heat source, a steam turbine 9 driven by the steam from the boiler 8, a condenser 1 for condensing the steam exhausted from the steam turbine 9, a feedwater pump (water feeder) 4 for feeding the water condensed in the condenser 1 to the boiler 8, and a circulation channel 21 sequentially connecting the boiler 8, the steam turbine 9, the condenser 1, and the feedwater pump 4. In this steam plant, a low-pressure heater 2 and a deaerator 3 are disposed in the channel 21, in this order from the upstream side, covering a region from the condenser 1 to the feedwater pump 4, and a high-pressure heater 6 is disposed in the channel 21 covering a region from the feedwater pump 4 to the boiler 8.

The above-mentioned “prescribed device” can be a device experiencing the problem of scale adhesion in the steam plant. In an example of this embodiment, a case where the “prescribed device” is a feedwater pump 4 will be described, but the “prescribed device” is not limited to the feedwater pump 4 in the present invention and may be a device experiencing the problem of scale adhesion caused by the same principle as in the feedwater pump in the steam plant, for example, a drain pump, a feedwater booster pump, a heater, an orifice, or a control valve.

In the water treatment process for the steam plant of this embodiment, a temporary change in the chemical environment is brought about in the channel inside a prescribed device disposed in the channel 21, during operation of the steam plant.

The water flowing in the channel inside the prescribed device of the steam plant is chemically affected by such a temporary change in the chemical environment. Consequently, the scale adhering to the inside of the prescribed device can be prevented by using a small amount of an agent.

The above-mentioned change in the chemical environment can be an increase in pH of water in the channel inside the prescribed device.

That is, for example, in the case where the prescribed device is a feedwater pump 4, the pH level of water flowing in the feedwater pump 4 is temporarily increased.

The range of the increase in pH is preferably 0.1 or more and 1.0 or less. An increase in pH less than 0.1 insufficiently prevents scale adhesion and is therefore undesirable. An increase in pH of 1.0 or greater may make the water highly alkaline, thus causing corrosion, and is therefore undesirable. In particular, the range of the increase in pH is preferably 0.3 or more and 0.7 or less.

The present invention is not limited by the pH level prior to the temporary increase in pH, and the pH level prior to the temporary increase may be a pH level in usual operation of the steam plant, which is about 9.3 in the case where the prescribed device is a feedwater pump 4.

The above-mentioned increase in pH can be achieved by temporarily injecting a certain agent into the channel near the prescribed device at the upstream side thereof or inside the prescribed device.

Alternatively, the increase in pH may be achieved by temporarily increasing the amount of a certain agent under the condition of constant injection of the agent into the channel near the prescribed device at the upstream side thereof or inside the prescribed device.

The method of injecting the agent is not particularly limited. For example, the injection can be conducted by supplying an agent stored in an agent tank (not shown) into the channel 21 near the prescribed device (feedwater pump 4) at the upstream side thereof or inside the prescribed device with a dosing pump 25. The injected amount of the agent can be controlled by, for example, controlling the driving voltage of the dosing pump 25, or by disposing a valve (not shown) at the outlet of the dosing pump 25 and controlling the degree of opening of the valve. Alternatively, the injected amount of the agent may be controlled by preparing a plurality of agent tanks storing the agent at various different concentrations, respectively, and switching between them.

The above-mentioned agent is preferably a volatile base. The volatile base can be one usually used in water treatment of a steam plant. For example, ammonia, ethanolamine, or morpholine are preferably used. In particular, ammonia is preferably used.

FIG. 2 contains graphs schematically showing examples of a change in pH of water in the channel 21 of the steam plant of this embodiment. FIG. 2(a) shows a change in pH in the channel 21 at an agent-injecting site near the inlet of the feedwater pump 4 at the upstream side thereof, and FIG. 2(b) shows a change in pH in the channel 21 in the feedwater pump 4. In both FIGS. 2(a) and 2(b), the horizontal axis represents time (arbitrary units), and the vertical axis represents pH (arbitrary units).

As shown in FIG. 2(a), in the channel 21 at the agent-injecting site near the inlet of the feedwater pump 4 at the upstream side thereof, the pH of water can be changed in a rectangular shape by sharply raising and reducing the amount of the agent injected. However, since the injected agent is gradually mixed with water in the channel 21 from this injection site to the feedwater pump 4, the change of pH of the water is flattened in the channel 21 in the feedwater pump 4, as shown in FIG. 2(b). Therefore, in order to sufficiently prevent scale adhesion, it is preferable to inject the agent into the channel 21 at a site nearest a prescribed device for which scale adhesion is to be prevented (feedwater pump 4) at the upstream side thereof or in the prescribed device.

In this embodiment, a temporary change in the chemical environment in the channel in the feedwater pump 4 may be brought about, for example, at constant intervals of from about one hour to about one month. Alternatively, the driving power of the feedwater pump 4 may be monitored, and the above-mentioned change of the chemical environment may be brought about when the driving power of the feedwater pump 4 is decreased to a predetermined threshold level. Alternatively, the pH level may be monitored with a pH meter 26 disposed at the downstream side of the feedwater pump 4 (in FIG. 1, at the downstream side of the high-pressure heater 6), and the above-mentioned change of the chemical environment may be brought about when this pH is decreased to a predetermined threshold level.

In this embodiment, an increase in pH is described as an example of the change of the chemical environment, but the change of the chemical environment of the present invention is not limited thereto. For example, as a change in chemical environment, the solubility of iron may be changed by temporarily changing the oxidation-reduction potential of water. In such a case, for example, hydrazine or oxygen can be used as the agent: more usually, hydrazine can be used.

### Second Embodiment

A water treatment process for a steam plant according to a second embodiment of the present invention will now be described. Since the structure of the steam plant to be treated with the water treatment process of this embodiment is the same as that of the steam plant to be treated with the water treatment process of the first embodiment shown in FIG. 1, this embodiment will also be described with reference to FIG. 1, and a description of the same components is omitted.

In the water treatment process for the steam plant of this embodiment, a variation in the chemical environment may be brought about, approximately periodically, in the channel inside a prescribed device disposed in the circulation channel 21, during operation of the steam plant.

In this embodiment, the above-mentioned “prescribed device” can be a device experiencing the problem of scale adhesion in the steam plant, as in the first embodiment. In an example of this embodiment, a case where the “prescribed device” is a feedwater pump 4 will be described, but the “prescribed device” is not limited to the feedwater pump 4 in the present invention and may be a device experiencing the problem of scale adhesion caused by the same principle as in the feedwater pump in the steam plant, for example, a drain pump, a feedwater booster pump, a heater, an orifice, or a control valve.

With such a temporary variation in the chemical environment, a chemical oscillation is imparted to the water flowing in the channel inside the prescribed device of the steam plant. Consequently, the scale adhering to the inside of the prescribed device can be prevented by using a small amount of an agent.

The above-mentioned variation in the chemical environment can be a fluctuation in the pH of water in the channel inside the prescribed device.

That is, for example, in the case where the prescribed device is a feedwater pump 4, an approximately periodic fluctuation in pH is applied to water flowing in the feedwater pump 4.

The range of the fluctuation in pH is preferably within ±0.05 to ±0.3 of a predetermined standard value. A pH fluctuation range smaller than ±0.05 leads to insufficient prevention of scale adhesion and is therefore undesirable. In contrast, a pH fluctuation range larger than ±0.3 adversely affects the durability of the channel 21. A particularly preferred pH fluctuation range is about ±0.1 of a predetermined standard value.

In addition, the present invention is not limited by the above-mentioned “predetermined standard value”, and the “predetermined standard value” can be a pH level in usual operation of a steam plant. For example, in the case where the prescribed device is a feedwater pump 4, the “predetermined standard value” can be a pH of about 9.3.

The cycle of the above-mentioned fluctuation in pH is preferably within the range of from 5 minutes to 1 hour. A cycle shorter than 5 minutes averages the fluctuation in pH at a portion where scale adhesion should be prevented, thus decreasing the effect, which is undesirable. A cycle longer than 1 hour causes the fluctuation in pH of the entire steam plant, which is undesirable. A cycle sufficiently shorter than 1 hour can bring about the fluctuation in pH selectively at the injection site.

The above-mentioned fluctuation in pH can be achieved by injecting a certain agent into the channel near the prescribed device at the upstream side thereof or inside the prescribed device, while changing the amount of the agent approximately periodically.

The method of injecting the agent is not particularly limited. For example, the injection can be conducted by supplying an agent stored in an agent tank (not shown) into the channel 21 near the prescribed device (feedwater pump 4) at the upstream side thereof or inside the prescribed device, with a dosing pump 25. The injected amount of the agent can be controlled by, for example, controlling the driving voltage of the dosing pump 25, or by disposing a valve (not shown) at the outlet of the dosing pump 25 and controlling the degree of opening of the valve.

The above-mentioned agent is preferably a volatile base. The volatile base can be one usually used in water treatment for a steam plant. For example, ammonia, ethanolamine, or morpholine are preferably used. In particular, ammonia is preferably used.

The volatile base is an agent that increases pH, but, when the steam plant is in operation, the pH of the water in the channel 21 gradually decreases by terminating the injection of the volatile base or reducing the injected amount. Consequently, an agent for reducing pH is not particularly necessary.

Also in this embodiment, for the same reason as described in the first embodiment, the agent is preferably injected into the channel 21 at a site nearest the prescribed device for which scale adhesion is to be prevented (feedwater pump 4) at the upstream side thereof or inside the prescribed device, in order to sufficiently prevent scale adhesion.

### Third Embodiment

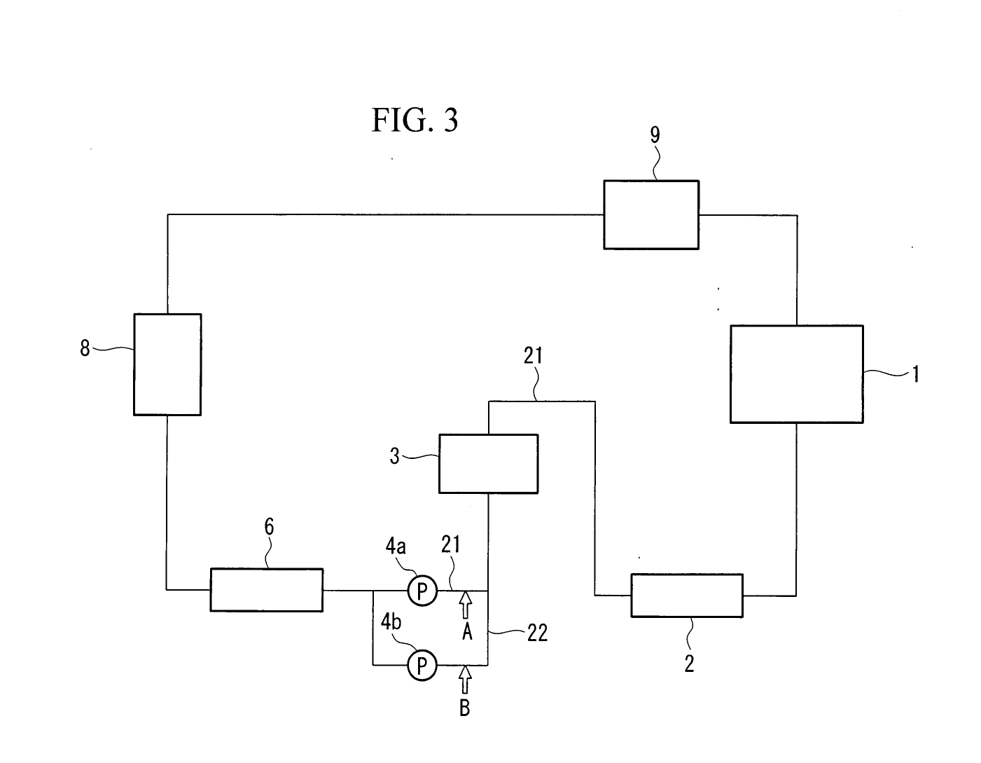

A water treatment process for a steam plant according to a third embodiment of the present invention will now be described with reference to FIG. 3.

FIG. 3 is a flow diagram showing an example of a steam plant to be treated with the water treatment process according to the third embodiment.

Since the structure of the steam plant to be treated with the water treatment process of this embodiment is the same as that of the steam plant to be treated with the water treatment process of the first and second embodiments shown in FIG. 1 except that a plurality of feedwater pumps (a first feedwater pump 4a and a second feedwater pump 4b) are disposed in parallel, a description of the same components is omitted.

Furthermore, since the types of the agents used in this embodiment are the same as those in the first and second embodiments, a description thereof is omitted.

The steam plant to be treated with the water treatment process of this embodiment has at least one branched channel 22 that is branched from the channel 21, in the steam plant treated with the water treatment process of the first or second embodiment, at the upstream side of the prescribed device (the first feedwater pump 4a), and becomes confluent with the channel 21 again at the downstream side of this device, and the same type of device (the second feedwater pump 4b) as the above-mentioned prescribed device is disposed in parallel in the branched channel. That is, in this embodiment, a plurality of the same type of devices (the first feedwater pump 4a and the second feedwater pump 4b) are arranged parallel to each other as the subjects in which scale adhesion is to be prevented.

In the water treatment process for the steam plant of this embodiment, a change in pH as in the first embodiment or a variation in pH as in the second embodiment is brought about in the respective channels 21 and 22 inside the plurality of the same type of devices to be prevented from scale adhesion, while maintaining an approximately constant pH in the channel 21 with which it becomes confluent after passing through these devices.

That is, the water treatment process for the steam plant of this embodiment can be conducted as follows: when the pH is increased, as in the first embodiment, by temporarily injecting a volatile base into the channel 21 near the prescribed device (the first feedwater pump 4a) at the upstream side (for example, the position A in FIG. 3) thereof or inside the prescribed device (the first feedwater pump 4a), the amount of the volatile base supplied to the same type of device (the second feedwater pump 4b) is reduced by approximately the same amount as that of the volatile base supplied to the prescribed device (the first feedwater pump 4a) under the condition of injection of the volatile base into the branched channel 22 near the same type of device (the second feedwater pump 4b) at the upstream side (for example, the position B in FIG. 3) thereof or inside the same type of device (the second feedwater pump 4b).

According to this process, by alternately injecting the volatile base to the prescribed device (the first feedwater pump 4a) and injecting the volatile base to the same type of device (the second feedwater pump 4b), it is possible to prevent scale adhesion in the channels inside this plurality of the same type of devices, while maintaining an approximately constant pH in the channel 21 with which it becomes confluent after passing through the plurality of the same type of devices (the first feedwater pump 4a and the second feedwater pump 4b).

Alternatively, the water treatment process for the steam plant of this embodiment can be conducted as follows: when the pH is increased, as in the first embodiment, by temporarily increasing the injected amount of a volatile base under the condition of constant injection of the volatile base into the channel 21 near the prescribed device (the first feedwater pump 4a) at the upstream side thereof (for example, the position A in FIG. 3) or inside the prescribed device (the first feedwater pump 4a), the amount of the volatile base supplied to the same type of device (the second feedwater pump 4b) is reduced by approximately the same amount as the increased amount of the volatile base supplied to the prescribed device, while the volatile base is being injected into the branched channel 22 near the same type of device (the second feedwater pump 4b) at the upstream side thereof (for example, the position B in FIG. 3) or inside the same type of device (the second feedwater pump 4b).

According to this process, by alternately increasing and decreasing the injected amount of the volatile base to the prescribed device (the first feedwater pump 4a) and increasing and decreasing the injected amount of the volatile base to the same type of device (the second feedwater pump 4b), it is possible to prevent scale adhesion in the channels inside this plurality of the same type of devices, while maintaining an approximately constant pH in the channel 21 with which it becomes confluent after passing through the plurality of the same type of devices (the first feedwater pump 4a and the second feedwater pump 4b).

Alternatively, the water treatment process for the steam plant of this embodiment can be conducted as follows: when a fluctuation in pH of the water in the channel 21 inside the prescribed device (the first feedwater pump 4a) is, as in the second embodiment, brought about, approximately periodically, in the channel 21 near the prescribed device (the first feedwater pump 4a) at the upstream side thereof or inside the prescribed device (the first feedwater pump 4a) by injecting the volatile base while causing an approximately periodic fluctuation in the injected amount thereof, the volatile base is injected into the branched channel 22 near the same type of device (the second feedwater pump 4b) at the upstream side thereof or inside the same type of device (the second feedwater pump 4b) while causing an approximately periodic fluctuation in the injected amount such that the fluctuation has a phase approximately opposite to that of the fluctuation in the amount supplied to the prescribed device (the first feedwater pump 4a).

According to this process, by increasing and decreasing the amount of volatile base injected into the prescribed device (the first feedwater pump 4a) approximately in opposite phase to that of the increasing and decreasing of the amount of volatile base injected into the same type of device (the second feedwater pump 4b), it is possible to prevent scale adhesion in the channels inside this plurality of the same type of devices, while maintaining an approximately constant pH in the channel 21 with which it becomes confluent after passing through the plurality of the same type of devices (the first feedwater pump 4a and the second feedwater pump 4b).

### Fourth Embodiment

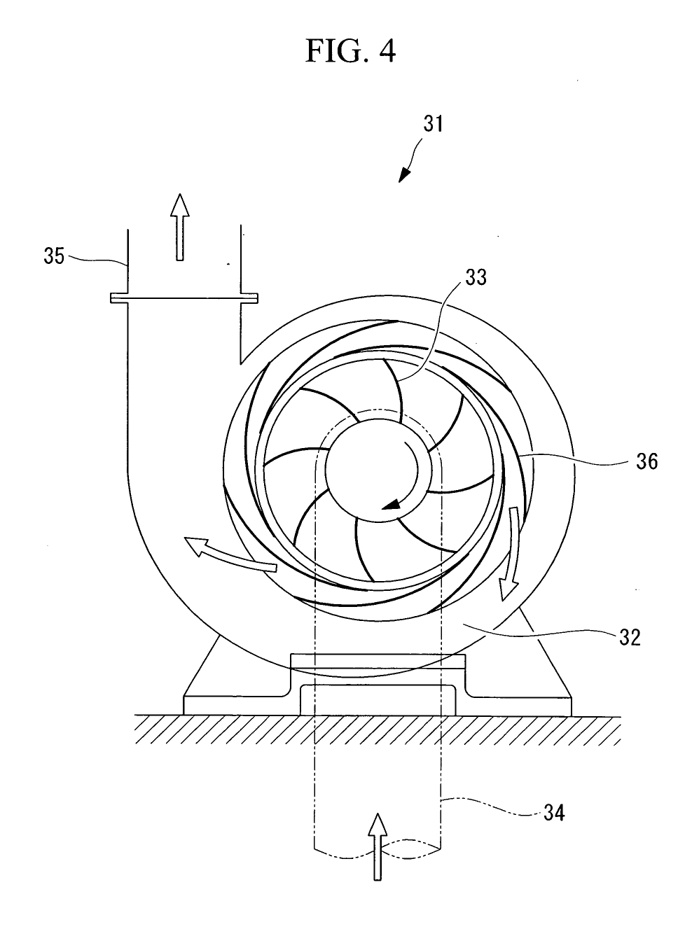

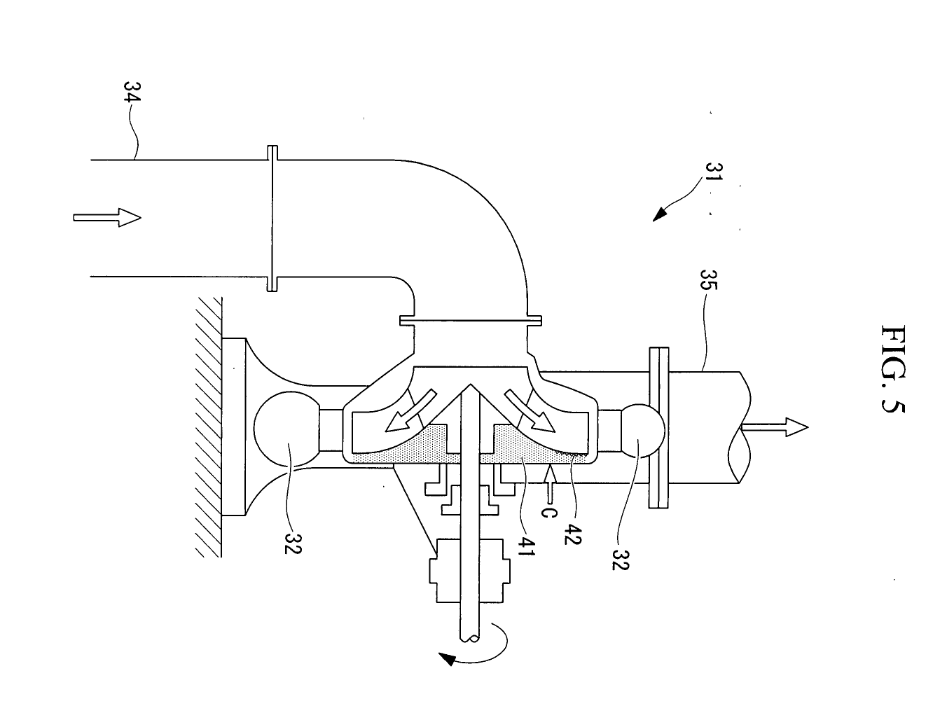

A water treatment process for a steam plant according to a fourth embodiment of the present invention will now be described with reference to FIGS. 4 and 5. Since the general structure of the steam plant to be treated with the water treatment process of this embodiment is the same as that of the first and second embodiments, a description thereof is omitted.

In this embodiment, the water feeder (the feedwater pump 4 in FIG. 1) is a centrifugal pump 31. FIGS. 4 and 5 are schematic cross-sectional views of the centrifugal pump 31: FIG. 4 is a view from the rotary axis direction of the impeller 33 described below, and FIG. 5 is a view from the lateral direction of the rotary axis of the impeller 33. This centrifugal pump 31 includes a volute chamber 32 and an approximately disk-shaped impeller 33 rotatably arranged in the volute chamber 32, and is configured so as to transfer water introduced to the center of the impeller 33 via a suction tube 34 from the outside of the volute chamber 32 to the outside of the volute chamber 32 from the circumference of the impeller 33 via a discharge tube 35 by a centrifugal force caused by the rotation of the impeller 33. In addition, the inside of the volute chamber 32 may be provided with a guide blade 36 for regulating the water flow at the outer circumference of the impeller 33.

In the centrifugal pump 31 having such a configuration, water in a gap 41 formed between the impeller 33 surface opposite to the surface at the water-introducing side and the inner surface of the volute chamber 32 hardly flows out to the outside, thus remaining in the gap. Consequently, scale 42 is easily formed on the surface of the impeller 33 in contact with this water remaining in the gap 41, which causes a decrease in efficiency of the centrifugal pump 31.

In the water treatment process for the steam plant of this embodiment, the water treatment is conducted by bringing about a change in the chemical environment in the gap 41 formed between the impeller 33 surface opposite to the surface at the water-introducing side and the inner surface of the volute chamber 32, during operation of the centrifugal pump 31.

In the water treatment process for the steam plant of this embodiment, since the water remains in the gap 41, it is not necessary to continuously inject an agent for changing the chemical environment, and the scale adhesion can be prevented by injecting a small amount of the agent.

The method of injecting the agent for bringing about a change in the chemical environment is not particularly limited. For example, the injection can be conducted by supplying an agent stored in an agent tank (not shown) into the gap 41 with a dosing pump (not shown). The injection site for injecting the agent into the gap 41 can be provided, as indicated by the character C in FIG. 5, on a wall of the volute chamber facing the wall on the opposite side from the water-introducing side of the impeller.

The injected amount of the agent can be controlled by, for example, controlling the driving voltage of the dosing pump, or by disposing a valve (not shown) at the outlet of the dosing pump and controlling the degree of opening of the valve.

In this embodiment, the above-mentioned change in the chemical environment can be an increase in pH of water in the gap.

An increase in pH of the water in the gap reduces the concentration of dissolved iron, thereby preventing scale adhesion.

In such a case, the pH of the water in the gap is preferably adjusted to 7 or more and 12 or less, and more preferably 9.5 or more and 11 or less, by increasing the pH. A pH of less than 7 of the water in the gap insufficiently prevents scale adhesion and is therefore undesirable. In contrast, a pH of higher than 12 of the water in the gap may cause corrosion by the highly alkaline water and is therefore undesirable.

The increase in pH can be achieved by injecting a volatile base into the gap. The volatile base can be the same as those shown in the first embodiment.

Furthermore, in this embodiment, the change in the chemical environment may be a decrease in pH of the water in the gap.

The decrease in pH of the water in the gap slightly increases the concentration of dissolved iron, but the solubility of iron is also increased, thus allowing a larger amount of iron to be dissolved. With this, scale can be dissolved, thereby preventing scale adhesion.

In such a case, the pH of the water in the gap is preferably adjusted to 5 or more and 9 or less, and more preferably 7 or more and 8.5 or less, by decreasing the pH. A pH of less than 5 of the water in the gap causes corrosion and is therefore undesirable. In contrast, a pH of higher than 9 of the water in the gap insufficiently prevents scale adhesion and is therefore undesirable.

The decrease in pH can be achieved by injecting an acid into the gap. The acid may be those generally used in water treatment for steam plants: for example, carbon dioxide, formic acid, acetic acid, or oxalic acid can be preferably used.

Hitherto, the embodiments of the water treatment process for the steam plant of the present invention have been described, but the present invention is not limited to the water treatment process for the steam plant composed of only the devices described in these embodiments and can be applied to steam plants including other devices. Furthermore, the present invention is not limited to application to a steam plant and can be applied to, for example, steam plants employed in thermal or nuclear power generation.

The water treatment process for a steam plant of the present invention will now be described in detail with reference to Examples.

### Example 1

A steam-plant water treatment process according to the above-mentioned first embodiment was performed, and the effectiveness in preventing scale adhesion in the feedwater pump 4 was investigated.

The pH in general operation of the steam plant was controlled to about 9.3 by injecting an agent such as ammonia into between the condenser 1 and the low-pressure heater 2. While continuously operating the steam plant, ammonia stored in the agent tank (not shown) was temporarily injected into the channel 21 near the feedwater pump 4 at the upstream side thereof with the dosing pump 25, thereby increasing the pH level in the channel 21 inside the feedwater pump 4 by about 0.3. When the pH level returned to the initial level, the operation for injecting ammonia was repeated in the same way.

Here, the term “temporary” injection includes cases where injection is conducted for one to ten minutes every sixty minutes and, in longer instances, injection is conducted for several hours every month. It also includes a case where temporary injection is conducted when a sign indicating a decrease in efficiency of the feedwater pump 4 is observed while monitoring the operating status of the feedwater pump 4.

In a conventional operating process of the steam plant, in one year of operation, the efficiency of the feedwater pump 4 was decreased by about 30% due to scale adhesion to the inside of the feedwater pump 4. However, with the process of this Example, it was possible to suppress the decrease in the efficiency of the feedwater pump 4 to about 15% in the operation of the steam plant for one year.

### Example 2

A steam-plant water treatment process according to the above-mentioned second embodiment was performed, and the effectiveness in preventing scale adhesion in the feedwater pump 4 was investigated.

The standard value of pH was controlled to about 9.3 by injecting an agent such as ammonia near an inlet of the feedwater pump 4. While continuously operating the steam plant, ammonia stored in the agent tank (not shown) was injected into the channel 21 near the feedwater pump 4 at the upstream side thereof with the dosing pump 25, while varying the injected amount such that the pH in the channel 21 inside the feedwater pump 4 varied, approximately periodically, within the range of ±0.1 of the standard value. The period of the variation in the pH was about 10 minutes.

Though scale gradually grows, the surface layer thereof is highly unstable. Accordingly, when only the pH near the feedwater pump 4 decreases, the scale dissolves. Therefore, the grown scale on the surface layer can be removed, resulting in prevention of scale growth. However, if the pH is constantly decreased, the pH in the entire plant is decreased. Therefore, it is necessary to vary the pH.

With the process of this Example, it was possible to suppress the decrease in the efficiency of the feedwater pump 4 to about 10% in the operation of the steam plant for one year.

### Example 3

A steam-plant water treatment process according to the above-mentioned third embodiment was performed, and the effectiveness in preventing scale adhesion in the first and second feedwater pumps 4a and 4b was investigated.

Ammonia was alternately injected from a position A in the channel 21 near the first feedwater pump 4a at the upstream side thereof and from a position B in the channel 22 near the second feedwater pump 4b at the upstream side thereof. The total amount of the injected amount from the position A and the injected amount from the position B was controlled to be constant, so that the pH at the confluent position of the channel 21 at the downstream side of the first feedwater pump 4a and the channel 22 at the downstream side of the second feedwater pump 4b was maintained constant at about 9.3.

With the process of this Example, it was possible to suppress the decrease in the efficiency of the first feedwater pump 4a and the second feedwater pump 4b to about 10% in the operation of the steam plant for one year.

### Example 4

A steam-plant water treatment process according to the above-mentioned fourth embodiment was performed, and the effectiveness in preventing scale adhesion in the centrifugal pump 31 was investigated.

During operation of the centrifugal pump 31, ammonia was injected into a gap 41 between the impeller 33 surface opposite to the surface at the water-introducing side and the inner surface of the volute chamber 32, from the position C in the drawing, to increase the pH of water in the gap 41 from about 9.3, which is the pH level in usual operation, to about 10, and the operation was continued.

With the process of this Example, it was possible to suppress the decrease in the efficiency of the centrifugal pump 31 to about 20% in the operation of the steam plant for one year.

### Example 5

A steam-plant water treatment process according to the above-mentioned fourth embodiment was performed, and the effectiveness in preventing scale adhesion in the centrifugal pump 31 was investigated.

During operation of the centrifugal pump 31, acetic acid was injected into a gap 41 between the impeller 33 surface opposite to the surface at the water-introducing side and the inner surface of the volute chamber 32, from the position C in the drawing, to decrease the pH of water in the gap 41 from about 9.3, which is the pH level in usual operation, to about 8.5, and the operation was continued.

With the process of this Example, it was possible to suppress the decrease in the efficiency of the centrifugal pump 31 to about 20% in the operation of the steam plant for one year.

1. A water treatment process for a steam plant including a steam generator for generating steam by heat from a heat source, a steam turbine driven by the steam from the steam generator, a condenser for condensing the steam exhausted from the steam turbine, a water feeder for feeding the water condensed in the condenser to the steam generator, and a circulation channel for sequentially connecting the steam generator, the steam turbine, the condenser, and the water feeder, wherein
a change in the chemical environment is temporarily brought about in the channel inside a prescribed device disposed in the channel, during operation of the steam plant.

2. The water treatment process according to claim 1, wherein the change in the chemical environment is an increase in pH of water in the channel inside the prescribed device.

3. The water treatment process according to claim 2, wherein the range of the increase in pH is 0.1 or more and 1.0 or less.

4. The water treatment process according to claim 2, wherein the increase in pH is achieved by temporarily injecting a volatile base into the channel near the prescribed device at the upstream side thereof or inside the prescribed device.

5. The water treatment process according to claim 2, wherein the increase in pH is achieved by temporarily increasing the injected amount of a volatile base under the condition of constant injection of the volatile base into the channel near the prescribed device at the upstream side thereof or inside the prescribed device.

6. The water treatment process according to claim 4, wherein the steam plant has at least one branched channel that is branched from the channel at the upstream side of the prescribed device and becomes confluent with the channel at the downstream side of the device, and the same type of device as the prescribed device is disposed in parallel in the branched channel; and
under the condition of injection of a volatile base into the branched channel near the same type of device at the upstream side thereof or inside the same type of device, the amount of the volatile base supplied to the same type of device is reduced, when the volatile base is supplied to the prescribed device, by approximately the same amount as that of the volatile base supplied to the prescribed device.

7. The water treatment process according to claim 5, wherein the steam plant has at least one branched channel that is branched from the channel at the upstream side of the prescribed device and becomes confluent with the channel at the downstream side of the device, and the same type of device as the prescribed device is disposed in parallel in the branched channel; and
under the condition of injection of a volatile base into the branched channel near the same type of device at the upstream side thereof or inside the same type of device, the amount of the volatile base supplied to the same type of device is reduced, when the amount supplied to the prescribed device is increased, by approximately the same amount as the increased amount of the volatile base supplied to the prescribed device.

8. A water treatment process for a steam plant including a steam generator for generating steam by heat from a heat source, a steam turbine driven by the steam from the steam generator, a condenser for condensing the steam exhausted from the steam turbine, a water feeder for feeding the water condensed in the condenser to the steam generator, and a circulation channel for sequentially connecting the steam generator, the steam turbine, the condenser, and the water feeder, wherein
a change in the chemical environment is brought about, approximately periodically, in the channel inside a prescribed device disposed in the channel, during operation of the steam plant.

9. The water treatment process according to claim 8, wherein the change in the chemical environment is a fluctuation in pH of water in the channel inside the prescribed device.

10. The water treatment process according to claim 9, wherein the range of the fluctuation in pH is within ±0.05 to ±0.3 of a predetermined standard value.

11. The water treatment process according to claim 9, wherein the cycle of the fluctuation in pH is within the range of from 5 minutes to 1 hour.

12. The water treatment process according to claim 9, wherein the fluctuation in pH is achieved by injecting a volatile base into the channel near the prescribed device at the upstream side thereof or inside the prescribed device, while varying the injected amount approximately periodically.

13. The water treatment process according to claim 12, wherein the steam plant has at least one branched channel that is branched from the channel at the upstream side of the prescribed device and becomes confluent with the channel at the downstream side of the device, and the same type of device as the prescribed device is disposed in parallel in the branched channel; and
a volatile base is injected into the branched channel near the same type of device at the upstream side thereof or inside the same type of device while causing an approximately periodic fluctuation in the injected amount such that the fluctuation has a phase approximately opposite to that of the fluctuation in the amount supplied to the prescribed device.

14. The water treatment process according to claim 1, wherein the prescribed device is the water feeder.

15. A water treatment process for a steam plant including a steam generator for generating steam by heat from a heat source, a steam turbine driven by the steam from the steam generator, a condenser for condensing the steam exhausted from the steam turbine, a water feeder for feeding the water condensed in the condenser to the steam generator, and a circulation channel for sequentially connecting the steam generator, the steam turbine, the condenser, and the water feeder, wherein
the water feeder is a centrifugal pump including a volute chamber and an approximately disk-shaped impeller rotatably arranged in the volute chamber and transferring water introduced to the center of the impeller from the outside of the volute chamber to the outside of the volute chamber from the circumference of the impeller by a centrifugal force caused by the rotation of the impeller; and
a change in the chemical environment is brought about in a gap between the impeller surface opposite to the surface at the water-introducing side and the inner surface of the volute chamber, during operation of the centrifugal pump.

16. The water treatment process according to claim 15, wherein the change in the chemical environment is an increase in pH of water in the gap.

17. The water treatment process according to claim 16, wherein the increase in pH makes the pH of water in the gap 7 or more and 12 or less.

18. The water treatment process according to claim 16, wherein the increase in pH is achieved by injecting a volatile base into the gap.

19. The water treatment process according to claim 15, wherein the change in the chemical environment is a decrease in pH of water in the gap.

20. The water treatment process according to claim 19, wherein the decrease in pH makes the pH of water in the gap 5 or more and 9 or less.

21. The water treatment process according to claim 19, wherein the decrease in pH is achieved by injecting an acid into the gap.
